(19) United States
(12) Patent Application Publication
(10) Pub. No.: US 2012/0094058 A1
(43) Pub. Date: Apr. 19, 2012

(54) WEB MATERIAL FOR SHEATHING PURPOSES

(76) Inventors: Elke ARNOLD, Gronau (DE); Frank Voogsgeerd, Enschede (NL)

(21) Appl. No.: 13/233,815

(22) Filed: Sep. 15, 2011

(30) Foreign Application Priority Data
Oct. 16, 2010 (DE) 102010 048 734.1

(51) Int. Cl. B32B 3/00; B32B 37/00; B32B 33/00

(52) U.S. Cl. 428/95; 428/190; 156/60

(57) ABSTRACT

Conventional decorative web materials used to sheathe vehicle interior surfaces are difficult to secure in place economically and are often not available in sufficient width to avoid unsightly seams. An improved composite sheathing material structure features a decorative first layer (1), a second layer (5) of foam or other resilient backing, and at least one textile band (3) adhered or welded to a backside of the decorative first layer (1), along at least one longitudinal side edge (2) thereof, and extending sidewise outward beyond the side edge (2) a few millimeters to a few centimeters, to provide a free edge region (4) to use for securing purposes. This conserves the amount of decorative material which must be used, and facilitates the connection of two webs to cover a wide surface, such as a passenger compartment ceiling, without leaving a visible seam.

### CROSS-REFERENCE TO RELATED APPLICATION

This application claims priority from our German application DE 10 2010 048 734.1, filed 16 Oct. 2010, the entire content of which is hereby incorporated by reference.

### FIELD OF THE INVENTION

The present invention relates to a web-shaped material for sheathing of surfaces, particularly the interior of motor vehicles, and particularly for sheathing of motor vehicle ceilings.

### BACKGROUND

It is known, in the sheathing of motor vehicle interiors, to use decorative materials like woven fabric, knit fabric, genuine leather, simulated leather or fleecy materials like, for example, ALCANTARA® (trademark of Alcantara S.p.A., Milan, Italy)or DINAMICA® (trademark of Fisi-Fibre Sintetiche S.p.A., Como, Italy). This decorative material is, to some extent, expensive, and is made only in specific widths. The commercially available widths are often insufficient for the sheathing of larger surfaces such as the ceiling of a motor vehicle, especially since the decorative material must be pulled around the side corner, of a form to be covered, and then secured on the backside of the form. This involves a waste of valuable material. A wider width can be achieved by sewing two webs together, along their adjacent longitudinal edges. However, this causes unattractive seams.

### SUMMARY OF THE INVENTION

Accordingly, an object of the invention is to provide an improved sheathing material which enables conservation of the amount of decorative material used, and also enables use of narrower webs.

In accordance with the invention, this object is achieved by adhering or welding a textile band or strip onto the backside of the web-shaped material, parallel to a side edge thereof, along one or both of the side edges of the web, as a handling aid. The textile preferably extends outward, beyond the web side edge, by a distance in the range from a few millimeters to a few centimeters. The textile band, adhered to the backside of the material web, serves, with its sidewise extending region, as a handling aid, in that this region, rather than the decorative material itself, is used for securing purposes. In this manner, the decorative material is conserved, and one can also employ narrower webs.

Advantageously, it is hereby proposed that the textile band have, transverse to its longitudinal direction, a higher tensile strength than in its longitudinal direction.

On the backside of web material, there is often glued a thin layer of foam or resilient backing or other textile or knitted fabric or plastic. In this case, the textile band is arranged between the foam or backing and the backside of the web material, so that the foam layer covers the textile band, at least up to the edge of the web material. In this connection, it is advantageous if the textile band and the foam layer can be applied to the backside of the web material in a single working step.

Preferably, it is proposed that the textile band comprise leather or simulated leather, particularly a leather-simulating microfiber material such as ALCANTARA®. The textile band may also comprise woven fabric, knitted fabric, a felt, or a highly compacted fleece. Further, it is proposed that the textile band have a thickness in the range from 0.05 mm to 0.5 mm.

### BRIEF FIGURE DESCRIPTION

FIG. 1 illustrates a preferred embodiment of the invention, which is described in greater detail below.

### DETAILED DESCRIPTION

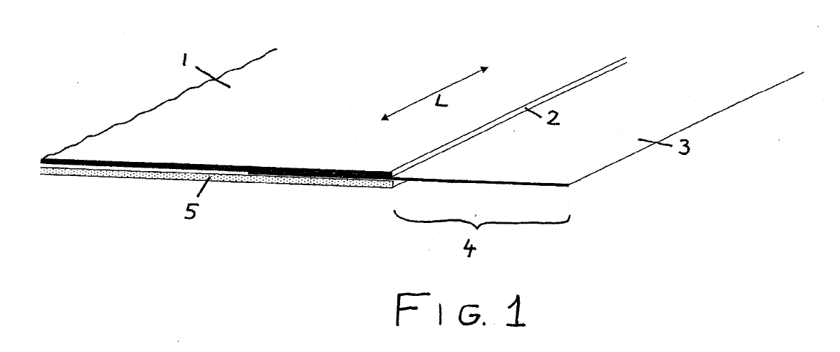

A material web 1, having a significantly greater length (in longitudinal direction L) than its width, has two outer longitudinal edges 2, and comprises decorative material such as leather or simulated leather, in particular a leather-simulating microfiber material (such as ALCANTARA®). Onto the backside of both side edges of the material web 1, there are glued or welded respective textile bands 3, parallel to the longitudinal edges 2, in such a way that each textile band extends beyond longitudinal edge 2, by a few millimeters to a few centimeters. Thus, the textile band 3 exposes, over the entire length of side edge 2, a free band-shaped region 4 as shown in FIG. 1.

This extended region 4 serves as a handling or fabrication aid, so that this region 4, rather than the valuable web material, can be used for securing purposes and, particularly, can be used for bending around the side corner of a component or form, intended to be sheathed with the decorative material.

A reliable and sufficient stretching-tight or pulling-until-flat of the material web is assured, if the textile band 3 has, transverse to its longitudinal direction, a higher tensile strength or resistance to stretching than in its longitudinal direction. The textile band comprises a woven fabric, a knitted fabric, a felt, or a highly compacted fleece and has a thickness in the range of 0.05 mm to 0.5 mm. On the backside of the material web, a thin foam layer 5 or analogous backing material or woven layer of 2 to 6 mm thickness can be adhered, the textile band 3 lying between the foam layer 5 and the material web 1. In this manner, the textile band 3 and the foam layer 5 can both be applied, in a single working step, onto the backside of the material web 1. For example, one could feed decorative material 1 from a first reel, textile band(s) 3 from a second reel and foam (5) from a third reel, into a nip formed by two rollers, while applying adhesive and/or heat to keep the resulting composite structure together.

It will be apparent, to those having ordinary skill in the application of decorative web material, that numerous modifications and variations are possible within the scope of the inventive concept. Therefore, the present invention is not limited to the specific embodiments shown and described, but rather is defined by the following claims.

What is claimed is:

1. Web-shaped material (1) for sheathing of surfaces, wherein:
on a backside of the web-shaped material, along at least one of two longitudinal edges (2), a textile band (3) is secured, which serves as a handling aid and extends outward beyond said at least one longitudinal edge (2) by a distance ranging from a few millimeters to a few centimeters.

2. Web-shaped material according to claim 1, wherein said textile band (3) has, transverse to its longitudinal direction, a higher resistance to stretching than in its longitudinal direction.

3. Web-shaped material according to claim 1, further comprising
a layer (5) of backing applied to said backside of said material, said textile band (3) being arranged between said layer (5) and said material (1).

4. Web-shaped material according to claim 1, wherein said textile band (3) comprises a leather.

5. Web-shaped material according to claim 1, wherein said textile band (3) comprises a leather-simulating plastic.

6. Web-shaped material according to claim 1, wherein said textile band (3) comprises a leather-simulating microfiber.

7. Web-shaped material according to claim 1, wherein said textile band (3) comprises a woven fabric.

8. Web-shaped material according to claim 1, wherein said textile band (3) comprises a knitted fabric.

9. Web-shaped material according to claim 1, wherein said textile band (3) comprises a felt.

10. Web-shaped material according to claim 1, wherein said textile band (3) comprises a fleece.

11. Web-shaped material according to claim 1, wherein said textile band (3) has a thickness in the range between 0.05 mm and 0.5 mm.

12. A method of making a multi-layer flexible sheathing material comprising the steps of feeding a web of decorative planar material (1) while applying, to a rear surface thereof, in a single working step, a layer of resilient backing material (5) and at least one intermediate layer of textile (3) extending sidewise (4) beyond at least one longitudinal side edge (2) of said decorative planar material (1).
